(19) United States
(12) Patent Application Publication
(10) Pub. No.: US 2010/0308976 A1
(43) Pub. Date: Dec. 9, 2010

(54) RADIOFREQUENCY COMMUNICATION DEVICE INCLUDING A TIMER

(75) Inventors: Frédérick Seban, Cassis (FR); Jean-Christophe Fidalgo, Gemenos (FR); Michael Zafrany, Marseille (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, MEUDON (FR)

(21) Appl. No.: 12/739,562

(22) PCT Filed: Sep. 30, 2008
(86) PCT No.: PCT/EP2008/063105

§ 371 Date: Apr. 23, 2010

(30) Foreign Application Priority Data
Oct. 26, 2007 (EP) 07301502.6

(51) Int. Cl. H04Q 5/22

(52) U.S. Cl. 340/10.5

(57) ABSTRACT

The invention relates to an electronic radiofrequency-transaction device that comprises a first switch capable of providing a radiofrequency operation of the device upon actuation of the switch and an operation stop when the actuation is released. The device is characterised in that it comprises a timer circuit capable of maintaining, after the actuation of the first switch, a continuous radiofrequency operation for a duration at least equal to the duration of a transaction to be carried out. The invention also relates to a smart card containing the device and to a module for an electronic radiofrequency-transaction device.

The invention relates to radiofrequency communication devices including an operation switch preventing the reading of the device without the holder knowing.

It more particularly relates to electronic radiofrequency-transaction devices that comprise a first switch capable of providing a radiofrequency operation of the device upon actuation of the switch and an operation stop when the actuation is released.

The firstly concerned devices for the invention are preferably smart cards of the contactless or hybrid type, inserts which include a radiofrequency antenna or, if need be, any support for the antenna circuit such as electronic passports. Such radiofrequency communication devices also called contactless transponders more particularly meet, for most of them, Standard ISO6IEC 14443. Form factors other than cards, such as USB keys, can be concerned by the invention.

Such devices are intended to provide the holder with means for accepting and/or denying access to data contained in said transponder to an external reading device. As a matter of fact, one of the problems raised by the contactless transponders concerned by the invention, and more particularly for sensitive applications, such as bank cards, electronic purse, e-passport, identification cards, results from the fact that the transponder can be polled by a remote reader and this operation can be carried out without the holder being aware thereof.

One of the means making it possible to remedy this drawback is the utilisation of a switch. This efficient means remains non-applicable for antennas, the lines of which do not exceed a certain width (1 mm). It is therefore difficult to establish contacts with the switch on antennas made of embedded wire or conductive wire fixed by embroidery or similar. Now today, using such conductive wires is preferred to comply with the various standards, all the more so since the devices are more and more miniaturised.

Such conductive wires, generally made of copper, are very thin (of the order of 113 μm) and spaced by approximately 700 μm to compose antenna windings and make it possible to obtain a higher quality factor, for example higher than 44, unlike antennas obtained through the deposition of a conductive material, more particularly by screen printing with a conductive ink. The diameter of the windings can be between 200 μm and 300 μm.

The inventors have identified two problems in the embodiment of contactless card with a switch.

Switches are positioned on an open path of the antenna so as to close the latter upon the actuation thereof and thus enable the RF function to be carried out during a transaction with a reader or another RF device. Such switches are exposed to contact failures during the transaction and thus the transaction can be incidentally interrupted.

A failing contact may result from a failure of the switch or an unintentional release of pressure by the user. This results in an increase in the time required for the transaction.

Another problem identified by the inventors is the presence of electric short-circuits in the switch which may interfere with the transaction. In both cases, the transaction must be resumed which is a waste of time for the user.

The aim of the invention is to solve the above-mentioned drawbacks.

The invention aims at reducing the transaction time resulting from the presence of the switch. It also aims at avoiding short-circuits in the switch.

The concept of the invention consists, in a preferred embodiment, upon a transaction which performs, for example, an extended checking of the holder and of the card, in reducing the time for the user to actuate the switch by adding an electronic timer (more particularly in the card body), related to the transaction communication time.

Thus, when the switch is actuated, it enables a capture of the power (the supply) of the reader through a (secondary) self thus making it possible to modify an RC (timer) circuit which will actuate a static switch for the duration required for the transaction.

The user can thus, through only one pulse on the switch, with a preserved tactile effect, avoid any “tearing” of the radiofrequency interface, i.e. any stop of the transaction RF resulting from a failure in the actuation of the switch.

The aim of the invention is thus an electronic radiofrequency-transaction device that comprises a first switch capable of providing a radiofrequency operation of the device upon actuation of the switch and an operation stop when the actuation is released.

The device is characterised in that it comprises a timer circuit capable of maintaining, after the actuation of the first switch, a continuous radiofrequency operation for a duration at least equal to the duration of a transaction to be carried out.

According to other characteristics of the device:
the timer circuit comprises or actuates a second switch positioned on a main antenna circuit, with said timer circuit being capable of having an actuation state wherein the second switch 8 closes the main antenna circuit;
the device is capable of obtaining the actuation state through the connection of the timer circuit to a source of power or means 9 collecting power and through the actuation of the first switch.
the collecting means is an electromagnetic coil.

The invention also relates to a smart card of the contactless type including the above-mentioned device. The smart card can have the main antenna circuit positioned in or on the integrated circuit or in a card body or on a module having a dielectric supporting the integrated circuit.

Another object of the invention is an integrated circuit module for an electronic radiofrequency-transaction device, with said integrated circuit being intended to contain a software transaction application in the integrated circuit.

The device is characterised in that it includes a timer circuit intended to maintain the integrated circuit supplied for at least the duration of the transaction.

Other characteristics and advantages of the invention will appear upon reading the following description which is given as a non-limitative example, and referring to the appended drawings wherein:

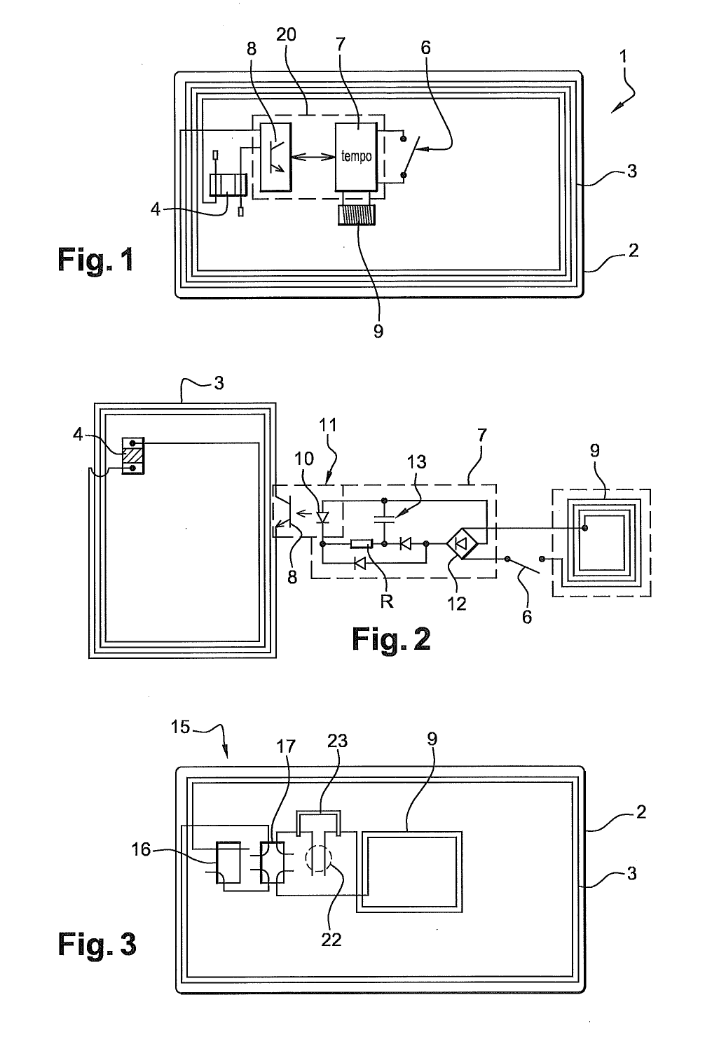

FIG. 1 schematically illustrates a radiofrequency device according to one embodiment of the invention;

FIG. 2 illustrates a detailed principle diagram of the electronic device corresponding to the one in FIG. 1;

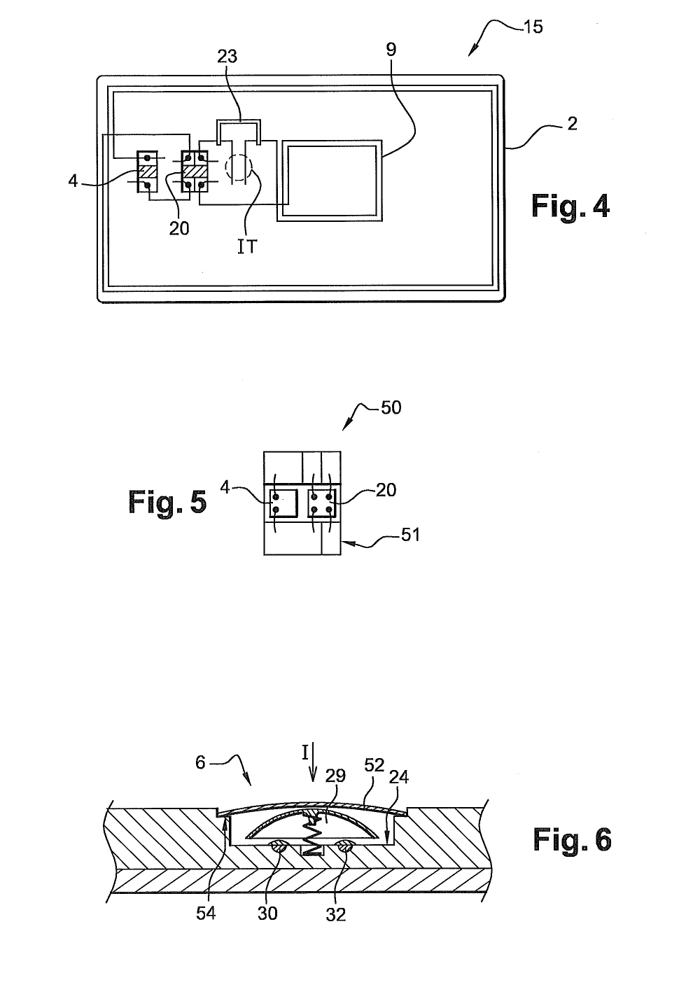

FIGS. 3 and 4 illustrate an exemplary embodiment and/or diagram showing the integration of an electronic circuit according to the invention in a support or an inlay for a smart card;

FIG. 5 illustrates an exemplary embodiment of a module comprising the so-called timer circuit and the integrated circuit intended to contain or containing an electronic software transaction application;

FIG. 6 illustrates an exemplary switch for a smart card.

As regards FIGS. 1 and 2, an electronic radiofrequency device 1 is, in the example, a smart card or an integrated circuit chip support, although other embodiments can implement the invention such as a USB key or any other portable object. The card includes, as is known, a support or a card body 2 including an electromagnetic antenna 3 in the plane of the support. Such antenna is connected to the terminals of an integrated circuit chip or to those of an electronic module or an electronic component 4 including same.

The chip is capable of implementing at least one software application stored therein to carry out an electronic transaction such as a bank payment, points, units, loyalty points debit or credit operations, access control, authentication, etc. The application can be implemented through the interaction with a radiofrequency reader or terminal or with another device of the same type as the invention including a function of the NFC (Near field communication) type.

The device also includes a first switch 6 capable of enabling a radiofrequency operation of the device upon the actuation of the switch and an operation stop after the actuation is released.

The switch is then open when at rests and breaks off a circuit of the device.

According to one characteristic of the embodiment of the invention, the device includes a circuit 7 capable of maintaining, after the actuation of the first switch 6, a continuous radiofrequency operation for a determined time.

Generally, the circuit 7 capable of maintaining a continuous radiofrequency operation after the actuation and the release of the first switch is called a timer. In fact, it is a circuit maintaining the operation of the antenna whatever the shape thereof; such circuit is independent of the condition of the switch after the actuation thereof. The time can be the time corresponding to the duration of the exposition of the device after the actuation of the main switch. Other equivalent circuits may be appropriate like relay circuits or timer circuits.

For example, a circuit of the bistable type, the actuated position of which actuates the device would be maintained so long as the device is exposed to the electromagnetic field, more particularly using a coil.

The timer circuit, which is broken off by the switch 6 at rest is also connected, on the one hand to a second switch 8 (the switch 8 can also be included in the timer circuit) and, on the other hand, to a source of power or a power collection means 9. In the example, this is an electromagnetic field coil 9. This will be used as a current generator under the effect of an electromagnetic field of a reader (not shown).

In another solution, the source (or the means 9) can be formed (or be replaced) by a specific fine battery, more particularly of the type used in smart cards or capable of being laminated or embedded in the support or inlay (the sub-assembly supporting an electric and/or electronic circuit).

The determined time, as mentioned above, corresponds, for example, at least to the time required for the completion of the considered transaction. The duration is preferably set during the manufacture or depends on the selected components.

According to another characteristic of the device, the timer circuit includes or actuates a second switch 8, 10, 11 positioned on a main antenna circuit 3. As a matter of fact, the second switch is an electronic switch of the static type and more particularly it is a LED diode 10 transistor 8 acting on the base of a transistor 8 to turn it on.

According to one characteristic, the timer circuit is capable of having an actuation state wherein the second switch (more particularly the transistor 8) is actuated to close the main antenna circuit 3.

For this purpose, in the example in FIG. 2, the first switch 6 has been connected so as to connect the power collecting means (here the coil) with the timer circuit 7. Then, a state of actuation or connection of the timer circuit with a source of power or a means capable of collecting power upon the actuation of the first switch, can be obtained.

The timer circuit 7 includes a rectifier circuit 12 and a capacity 13 connected to supply a threshold voltage for the actuation of the second switch and a loading voltage of a capacity 13 upon the actuation of the first switch 6.

The capacity of the timer circuit is determined so as to supply, by unloading, at least a threshold voltage through the actuation of the second switch for at least a duration corresponding to a radiofrequency-transaction. For example, the duration (D) may vary according to the length of the communication exchange from one thousandth of a second to 2 seconds or even 4. For a bank application, the minimum duration (D) is for example equal to a maximum duration required for a transaction of the EMV type.

In FIGS. 3, 4, for manufacturing the device and for practice, a timer circuit and a second electronic switch are positioned in a second electronic module component 20.

The radiofrequency device 1 is provided as an insert or “inlay” 15 for a contactless smart card, obtained according to a particular embodiment. In a first step (FIG. 3), the antenna 3 is made on a substrate or a support 2 in the form of a closed circuit, (except for the ends of the antenna intended to be connected to the electronic component 3). At the same time, or afterwards, the coil 9 is provided on the same substrate. The substrate preferably includes two cavities 16, 17 preferably provided prior to the antenna and the coil to respectively receive a first module 4 or an integrated circuit chip and the second electronic module or component 20 including the timer circuit and if need be the second electronic switch 2.

In the example, the wire for the antenna and/or the coil 9 is embedded in a polymer support 11 by an ultrasonic operation. The wires are ahead of the cavities and locations of the connections to the modules, and reach one edge of the cavity. The windings of the antenna and the coils could be manufactured otherwise using any known technique such as engraving or electrochemical deposition, cutting of a metallic sheet, screen printing, embroidery. The support can be made of various materials, more particularly synthetic ones and/or include cellulose fibres such as paper.

The coil 9 can be in closed circuit, at least momentarily, during the manufacturing and/or customisation of a zone 22 subsequently receiving or being able to receive a switch. For this purpose, a short circuit element, more particularly a fuse 23, can be positioned on a coil circuit 9 so as to short-circuit the switch or the terminals intended to connect a switch, with the element being capable of being opened during a subsequent step. Then, electric and customisation tests can be carried out even when the switch is mounted and without having to actuate it. The fuse is positioned here just before the positioning of the switch, but could be positioned any way so long as the switch is short-circuited by the fuse, for example just afterwards. The material of the fuse and the dimension or characteristics thereof are determined so that the fuse breaks off when the antenna is submitted to an electromagnetic field sufficiently strong to generate a breaking current or intensity.

The circle in dotted lines 22 illustrates a location in a zone 2 intended to receive the first switch or to be machined. The first switch is intended to be positioned on the coil circuit.

In FIG. 4, both electronic modules or components 4, 20 are positioned on the substrate prior to or after the provision of the antenna and the coil and connected together and to the coil and the antenna according to the electric diagram in FIG. 2 or 3.

Then, the transponder substrate provided with switches 6, 8 is covered with at least a sheet or a layer of a material (not shown) to form an “inlay” or a sub-assembly, also called an insert. The sheet can beforehand include a cavity 24 corresponding to the area 22 intended to receive a switch 6 provided according to FIG. 6, as an example.

FIG. 6 describes a switch 6, wherein the windings of the coil 30, 32 are not cut by a cavity accommodating a contact 29, thus being a dome including in the centre thereof, a spring partly accommodated in a mini central cavity in the cavity 24. The contacting element 29 is a Belleville type washer including a central dome possibly connected to four legs (not shown) in the shape of elastic lugs. Eventually, a flexible cap or membrane 52, accessible from the outside, is fixed, more particularly by gluing, on a plane 54 machined above the conductive element closing the cavity. The layer or sheet including the switch 6 is preferably made of two sheets or layers, with the antenna and/or the coil being at the interface thereof.

In an alternative embodiment illustrated in FIG. 5, both components or modules 4, 20 are arranged in only one electronic module or component 50. For this purpose, the module may include for example a metallized dielectric substrate 51 and locations for the integrated circuit 4 and a location for the component 20 forming or including the timer circuit and the electronic or optoelectronic switch. This facilitates the integration or connection of the module with the device during the manufacture.

According to alternative embodiments, in order to simplify the manufacturing and integrating operations, the antenna 3 and/or the coil 9 can be provided in the integrated circuit 4 or on the support 2 or on a dielectric 51 of the module 50.

The operation of the device is described hereinafter. A user places his or her bank card 1 in front of a bank terminal including a radiofrequency reading function. He or she enters his or her PIN code using the keyboard of the terminal and the user then validates the transaction, more particularly further to a mutual authentication step, by placing his or her card within the field of the reader and thus creating a pulse (I) on the first switch 6.

During the very short time of the pulse (for example less than one second), the circuit of the coil is closed in the presence of the electromagnetic field, the rectifying bridge, of the Wheatstone bridge type 12, supplies a continuous voltage which directly supplies the emitting diode LED 8 of the switch component, with the latter changing for a conduction state and closes the main antenna circuit.

As the main antenna is operational, it can receive in turn power from the field of the reader to supply the integrated circuit and generate a transaction more particularly through a back-modulation of the received field.

For the time of the pulse, the current or the voltage induced in the coil has also loaded the capacity 13 positioned at the terminals of the assembly composed of the diode LED 10 and the resistance R.

After the pulse, the user can release the first switch 6 since the capacity 13, when unloading, in turn supplies the diode 10 to maintain the antenna circuit 3 closed. If need be, a diode may be positioned just after the bridge 12 or on the “shunt” element of the resistance and diode.

If the duration of the transaction exceeds that of the impulsion (I) or the actuation, the transaction can be advantageously continued without having to keep the switch actuated for any longer as long as the capacity supplies a voltage which is greater than a threshold voltage (TS) required for actuating the electronic switch.

The device can also be an identification document, an electronic passport or be included therein.

1. An electronic radiofrequency-transaction device that comprises a first switch capable of providing a radiofrequency operation of the device upon actuation of a switch and an operation stop when the actuation is released,
wherein it comprises a timer circuit capable of maintaining, after the actuation of the first switch, a continuous switching radiofrequency operation for a duration at least equal to the duration of a transaction to be carried out.

2. A device according to claim 1, wherein the timer circuit comprises or actuates a second switch positioned on a main antenna circuit, with said timer circuit being capable of having an actuation state wherein such second switch closes the main antenna circuit.

3. A device according to claim 1, wherein it is capable of obtaining the actuation state through the connection of a timer circuit to a source of power or to means collecting power and through the actuation of the first switch.

4. A device according to claim 2, wherein the first switch is so connected as to break off the timer circuit.

5. A device according to claim 2, wherein the first switch is so connected as to break off the source of power or the power collecting means.

6. A device according to claim 5, wherein the collecting means is an electromagnetic coil.

7. A device according to claim 5, wherein the source of power is a battery.

8. A device according to claim 1, wherein the second switch is a static electronic switch.

9. A device according to claim 1, wherein the timer circuit comprises a rectifier circuit to supply a threshold voltage for the actuation of the second switch and a loaded voltage of a capacity upon the actuation of the first switch.

10. The capacity of the timer circuit is so determined as to supply, by unloading, at least a threshold voltage for the actuation of the second switch for at least the duration corresponding to a radiofrequency-transaction.

11. A device according to claim 1, wherein the timer circuit and the second electronic switch are positioned together in a second electronic module or component.

12. A device according to claim 1, wherein the second electronic module or component is positioned on the antenna circuit and is connected to a coil positioned on the support.

13. A device according to claim 6, wherein the first switch is positioned on the coil circuit.

14. A smart card of the contactless type comprising the device according to claim 1.

15. A smart card according to claim 14, wherein the main antenna circuit is positioned in or on the integrated circuit or on a card body or on a module having a dielectric supporting the integrated circuit.

16. An integrated circuit module for a radiofrequency-transaction electronic device, said integrated circuit being intended to contain a software transaction application in the integrated circuit, wherein it comprises a timer circuit intended to maintain the integrated circuit supplied for at least the duration of the transaction.
